(19) United States
(12) Patent Application Publication
(10) Pub. No.: US 2025/0331084 A1
(43) Pub. Date: Oct. 23, 2025

(54) MULTI-FUNCTION, MULTI-STRING LED LIGHTING SYSTEM

(71) Applicant: Holiday Designs, LLC, Bannockburn, IL (US)

(72) Inventor: Chunwa Nguy, Cornelius, NC (US)

(21) Appl. No.: 19/098,364

(22) Filed: Apr. 2, 2025

Related U.S. Application Data
(60) Provisional application No. 63/637,102, filed on Apr. 22, 2024.
(60) Provisional application No. 63/693,324, filed on Sep. 11, 2024.

(51) Int. Cl. H05B 47/155; F21S 4/10; F21Y 113/17; F21Y 115/10; H05B 45/10; H05B 45/20; H05B 45/37; H05B 47/17

(52) U.S. Cl. CPC H05B 47/155; F21S 4/10; H05B 45/10; H05B 45/20; H05B 45/37; H05B 47/17; F21Y 2113/17; F21Y 2115/10

(57) ABSTRACT

An LED lighting system includes an AC/DC and/or DC/DC power converter, a controller, and a first light set comprising a first light string and a second light string. Each the first light string and the second light string has a plurality of bulbs. Each bulb has a first diode ED and a second diode. The first diode and the second diode emit light of a different color from each other. The first light string and the second light string are electrically connected to the controller and are illuminable independently of one another. An upstanding structure having an LED lighting system and a controller are also disclosed.

### CROSS-REFERENCE TO RELATED APPLICATION DATA

This application claims the benefit of, and priority to Provisional U.S. Patent application Ser. No. 63/637,102, filed Apr. 22, 2024, titled, MULTI-FUNCTION, MULTI-STRING LED LIGHTING SYSTEM, and Provisional U.S. Patent application Ser. No. 63/693,324, filed Sep. 11, 2024, titled MULTI-FUNCTION, MULTI-STRING LED LIGHTING SYSTEM, the disclosures of which are incorporated herein in their entireties.

### BACKGROUND

The present disclosure is directed to LED light strings, and more particularly to a multi-function, multi-string LED lighting system.

LED lighting systems are in wide-spread use. These systems are used in decorating, for example, home interiors, home exteriors, trees, bushes, and the like. In recent years, LED lighting systems have replaced conventional incandescent lighting systems for use on Christmas trees, and other holiday lighting schemes.

Some LED lighting systems are sophisticated and use red, green, blue (RGB) LEDs. While these systems provide some measure of flexibility in lighting schemes, they can be quite costly to manufacture. Other lighting systems are quite elementary and may include a single color LED (for example, a white LED, or a red LED) or a two color LED (for example, a white LED and a red LED within one lens or case), that can be programmed for simple lighting scenarios such as solid on, flashing, blinking and the like.

A typical LED lighting system includes an AC to DC (AC/DC) converter, a controller, and a light string. The converter provides power for the system, and the controller provides functionality to the lighting system. Typically, a current controller is provided in concert with the AC/DC converter to control the current to the LEDs. The controller may include circuitry to control the power/current to the LEDs. The circuitry may include, for example pulse width modulation circuitry to control the power to the LEDs. Such circuitry pulses power to the LEDs at a frequency sufficiently high that the human eye perceives a steady light. In RGB systems, varying the pulse time (length) and timing can provide colors beyond red, green, and blue.

One drawback to know systems is that they are “single string” systems. That is, there is one line or string of LEDs from the controller and control signals for all of the LEDs are transmitted along that single string. This arrangement limits the lighting scenarios that are available for the light string. This is particularly limiting for single color LED systems.

Accordingly, there is a need for a LED lighting system that provides multiple functions. Desirably, such a system includes a single controller and multiple LED strings to provide such functionality. More desirably still, such a system uses a variety of LED types to provide a wide variety of lighting schemes or scenarios.

### BRIEF SUMMARY

In an aspect, an LED lighting system according to an embodiment includes an AC/DC and/or DC/DC power converter, a controller, and a first light set comprising a first light string and a second light string. Each the first light string and the second light string have a plurality of bulbs. Each bulb has a first diode and a second diode, the first diode and the second diode are configured to emit light of a different color from each other. The first light string and the second light string are electrically connected to the controller and are illuminable independently of one another.

In an embodiment, the first diodes of the first light string can emit a white light and the second diodes of the first light string can emit a light of a color other than white. The first diodes of the second light string can emit a white light and the second diodes of the second light string can emit a light of a color other than white. The color other than white can be one of, for example, red, green, blue, purple, and orange.

In an embodiment, each first diode and each second diode is illuminable in one or more of, for example, a steady illumination, a flashing illumination, a fading illumination, a slow glow illumination, and a twinkle illumination.

In embodiments, the LED lighting system further includes a second light set. The second light set can include a second light set first light string and a second light set second light string. Each the second light set first light string and the second light set second light string have a plurality of bulbs. Each bulb has a first diode and a second diode, and the first and second diodes can emit light of a different color from each other. The second light set first and second light strings are electrically connected to the controller and are illuminable independently of one another.

In embodiments, the first light set and the second light set are illuminable in coordination with one another. In embodiments, the LED lighting system can include a third light set, and the first light set, the second light set, and the third light set can be illuminable in coordination with one another.

In embodiments, the LED lighting system further includes a fourth light set, and the first light set, the second light set, the third light set, and the fourth light set can be illuminable in coordination with one another.

In embodiments, the LED light set is illuminable in at least eight lighting scenarios. In some embodiments, the LED lighting system is illuminable in at least thirty-two (32) lighting scenarios, and in some embodiments, the LED lighting system is illuminable in at least eighty (80) lighting scenarios. The LEDs can be red/green/blue (RGB), red/green/blue/white (RGBW) or separate colored LEDs.

In another aspect a controller is configured for use with an LED lighting system having an AC/DC and/or DC/DC power converter and a first light set comprising a first light string and a second light string, each the first light string and the second light string having a plurality of bulbs, each bulb having a first diode and a second diode, the first diode and the second diode can emit light of a different color from each other, the first light string and the second light string electrically connected to the controller and are illuminable independently of one another.

The controller includes a face plate having a plurality of switches. The switches include at least three preset switches. Each preset switch illuminates the first light string in a first color and the second light string in a second color. The controller is configured to illuminate the first and second light strings independent of each other.

The first color can be different from the second color, or it can be the same as the second color. In embodiments, the at least three preset switches illuminate the first and second light strings in holiday themed colors. The holiday themed colors can include red, white, and blue for United States Independence Day, purple, green, and orange for Halloween, and red, green, and white for Christmas.

In another aspect, an upstanding structure has an LED lighting system. The upstanding structure is a self-supporting structure. The LED lighting system includes an AC/DC and/or DC/DC power converter, a controller, and a first light set comprising a first light string and a second light string. Each the first light string and the second light string have a plurality of bulbs. Each bulb has a first diode and a second diode. The first diode and the second diode can emit light of a different color from each other. The first light string and the second light string are electrically connected to the controller and are illuminable independently of one another.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 illustrates an example of a lighting scenario, and schematically, the wiring, for a multi-function, multi-string LED lighting system in accordance with the present disclosure;

FIG. 2 illustrates another example of a lighting scenario of the multi-string LED lighting system in accordance with the present disclosure;

FIG. 3 is a wiring diagram of an example controller for a multi-function, multi-string LED lighting system;

FIGS. 4A and 4B are schematic illustrations of a pole set for use with wiring for a multi-function, multi-string LED lighting system, for example, for a lighted tree, in which FIG. 4A shows the physical tree structure, and in which FIG. 4B shows the lighting system with three (3) sets of light strings;

FIGS. 5A and 5B are schematic illustrations of an LED “bulb” which contains two light emitting diodes within one lens or case;

FIG. 6 is a schematic illustration of a wiring diagram for a multi-function, multi-string LED lighting system having four light sets;

FIG. 7 illustrates an example of a wire set;

FIGS. 8A-8C are illustrations of a controller in which FIG. 8A illustrates an embodiment of a face panel for a controller for the multi-function, multi-string light system, FIG. 8B illustrates a printed circuit board (PCB) of the controller, and FIG. 8C illustrates a schematic diagram of the controller, which controller may be used with a preset holiday version of the multi-function, multi-string LED lighting system;

FIGS. 9A-9C are illustrations of another controller in which FIG. 9A illustrates an embodiment of a face panel for a controller for the multi-function, multi-string light system, FIG. 9B illustrates a printed circuit board (PCB) of the controller, and FIG. 9C illustrates a schematic diagram of the controller which controller may be used with a multi-color, color changing version of the multi-function, multi-string LED lighting system; and

FIGS. 10A-10C are illustrations of still another controller in which FIG. 10A illustrates an embodiment of a face panel for a controller for the multi-function, multi-string light system, FIG. 10B illustrates a printed circuit board (PCB) of the controller, and FIG. 10C illustrates various parts of schematic and wiring diagrams of a controller, which controller may be used with a multi-color, color changing version of the multi-function, multi-string LED lighting system.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

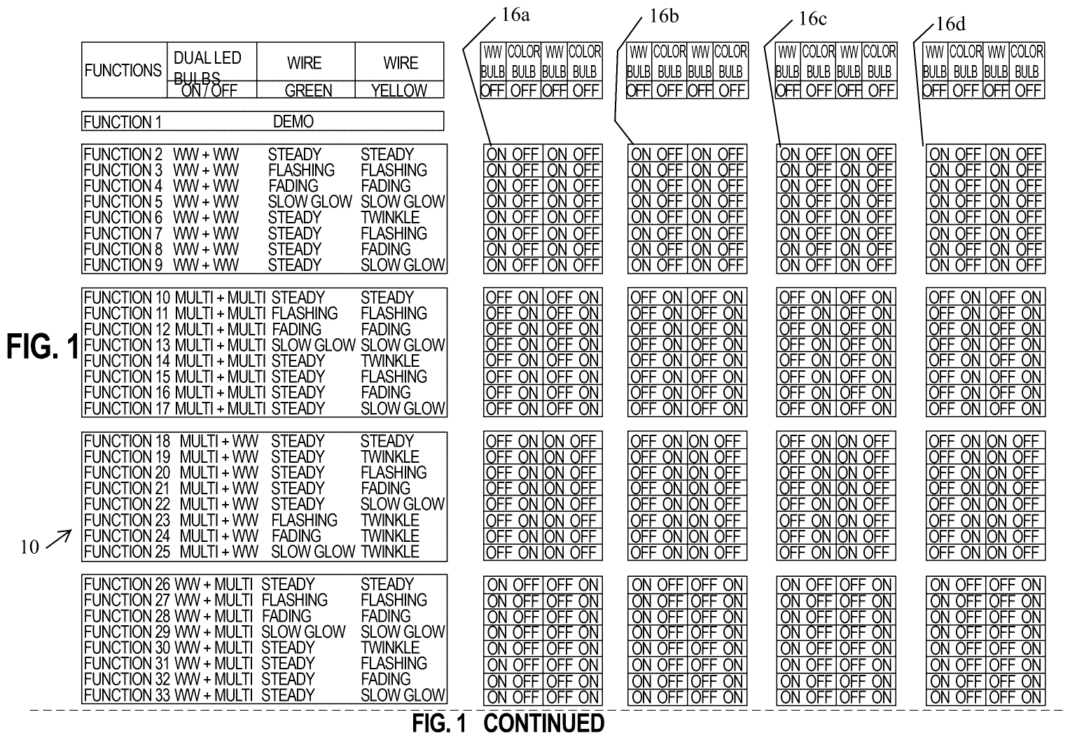

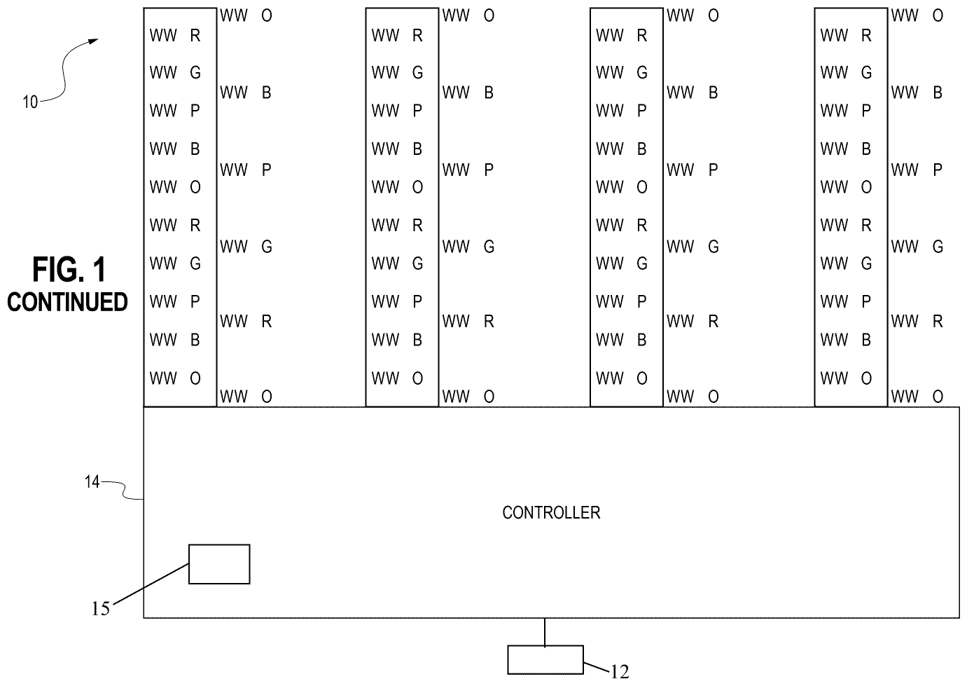

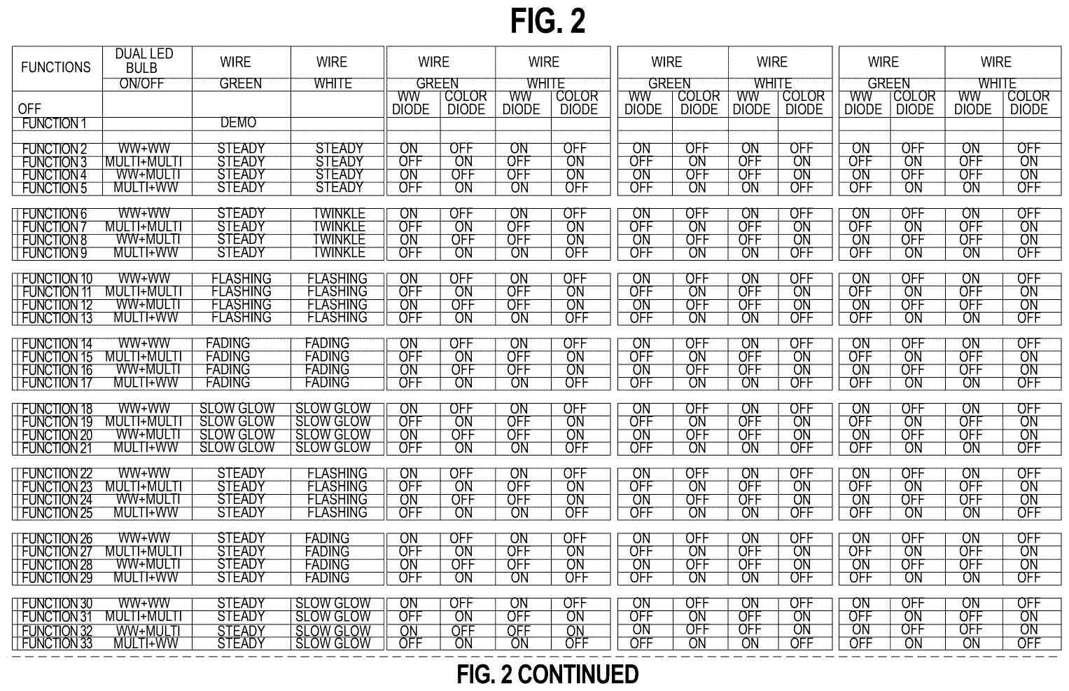

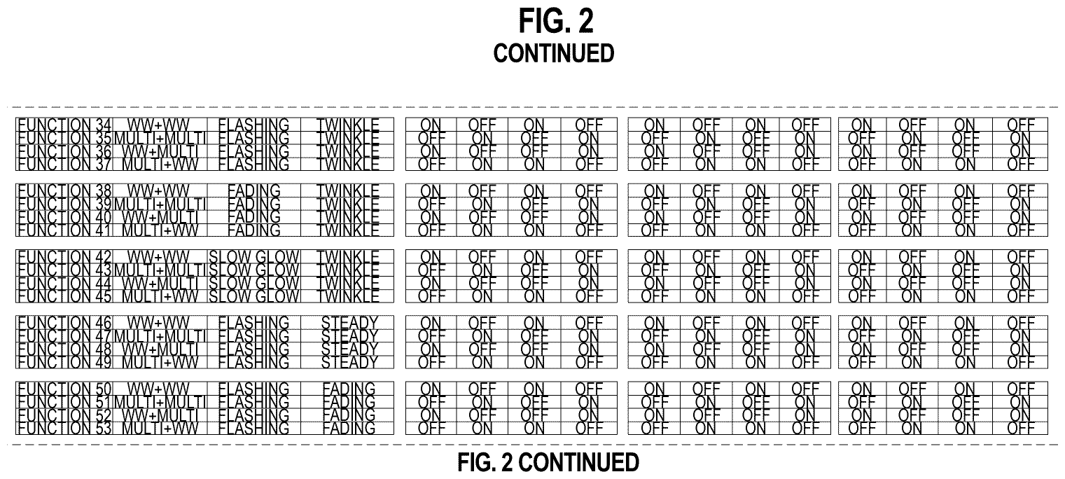

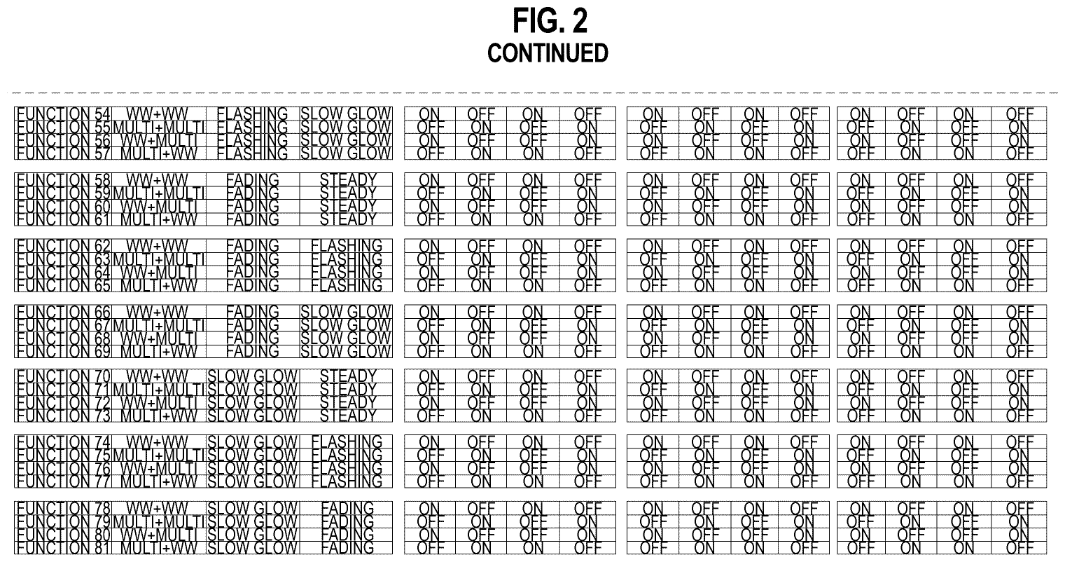

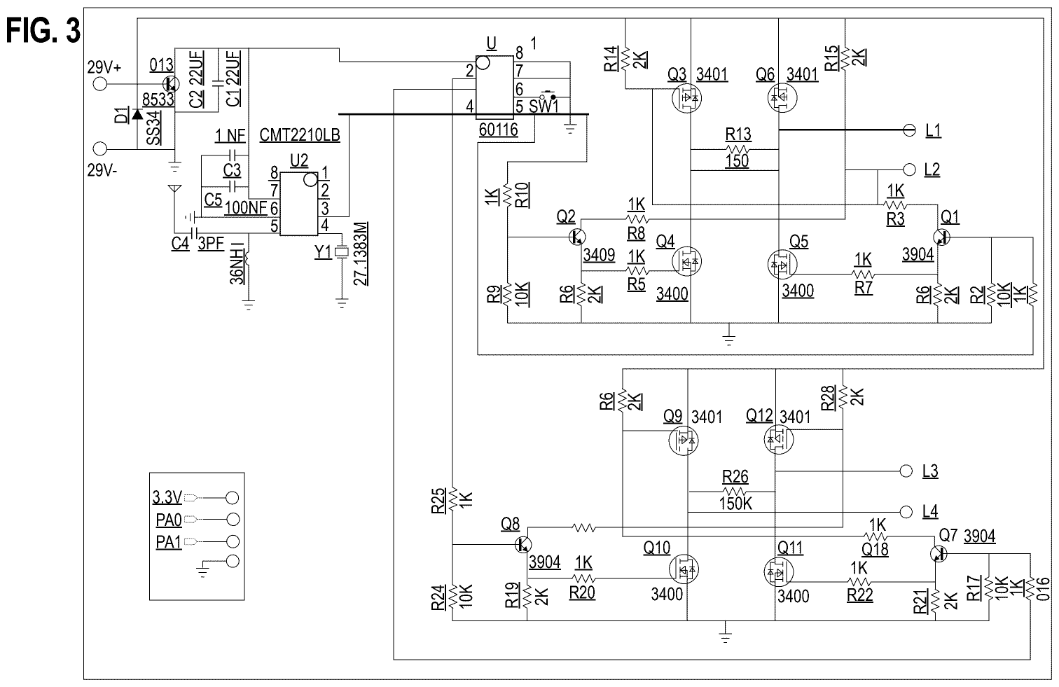

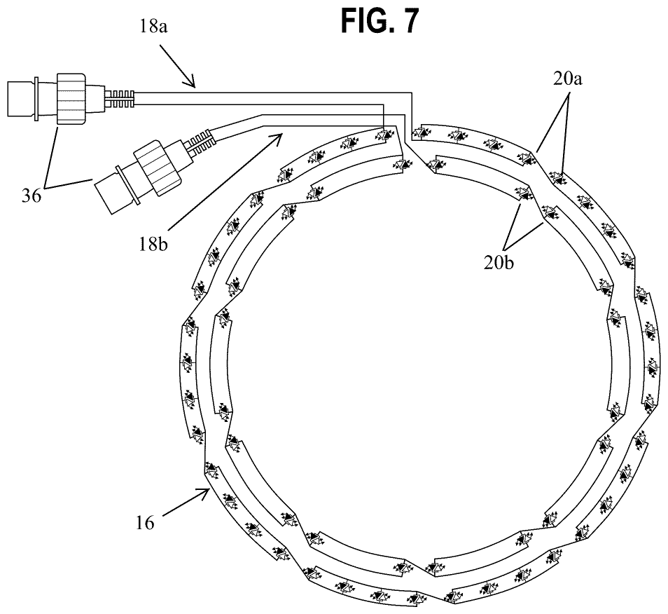

Referring now to the figures and in particular to FIG. 1, there is shown an example of a lighting scenario, and schematically, the wiring, for a multi-function, multi-string LED lighting system 10 in accordance with the present disclosure. The system 10 includes an AC/DC power converter 12 and/or DC/DC power converter 15, a controller 14, multiple wire sets 16, each including two light strings 18a,b, and each light string 18a,b including a plurality of bulbs 20 electrically connected thereto. The controller 14 may include a DC/DC power converter 15 to provide power to the light strings 18 at a desired voltage. An example of a wire set is illustrated in FIG. 7.

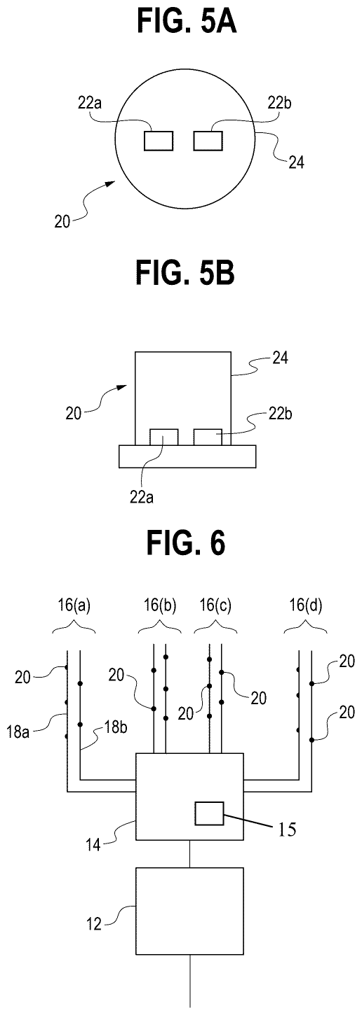

Referring to FIGS. 5A and 5B, in an illustrated embodiment, each bulb 20 or LED is a two color LED. The bulbs 20 can include, for example a white emitting diode 22a and a color emitting diode 22b. Those skilled in the art will recognize that the two diodes (the white illuminating diode 22a and the color emitting diode 22b) are contained within one lens or case 24 and as such appear to be a single LED, and that when, for example, current is applied to the white illuminating diode 22a, the “LED” emits a white luminescence, and when, for example, current is applied to color (e.g., the red illuminating) diode 22b, the “LED” emits a red luminescence. Referring to FIGS. 5A and 5B, for purposes of the present disclosure, the single case or lens 24 containing the two diodes 22a,b within the is referred to as a “bulb” 20.

In an embodiment the system 10 includes two light strings 18a,b. Each bulb 20 on each light string 18a,b can include two diodes 22a,b. In a current embodiment, one diode 22a is a white illuminating diode and the other diode 22b is a non-white or color illuminating diode. The white illuminating diode 22a can be, for example, a warm white diode and the color diode 22b can be, for example, red, green, blue, purple, orange, or any other color illuminating diode. The color diodes 22b on each string 18a,b need not be the same color, and preferably, are not the same color. For example on a string, for example, string 18a, a first bulb 20a can have a white diode 22a and a red diode 22b, a second bulb 20b can have a white diode 22a and a green diode 22b, the third bulb 20c can have a white diode 22a and a purple diode 22b, and so on, so that each bulb 20 on each string 18a,b has a white diode 22a and a color diode 22b different from its adjacent bulbs 20.

In a current embodiment, each string 18a,b functions independently from the other string 18b,a and the diodes 22a,b on each string 18a,b can illuminate either white or their respective color. In addition, the diodes 22a,b on each string 18a,b can have one or more of a variety of special illuminating or visual features or effects. For example, the white and color diodes 22a,b can have a steady illumination, a flashing illumination, a fading illumination, a slow glow illumination, or a twinkle illumination. The special effects can be effected by use of pulse width modulation (PWM) or other programming that will be recognized by those skilled in the art.

In a current embodiment of the multi-function, multi-string LED lighting system 10, there are thirty two (32) lighting scenarios or modes and a demonstration mode (not shown). One example of thirty two lighting scenarios is shown in Table 1, below.

TABLE 1
Lighting Scenarios or Modes

| | | Light String 1 | | | | | |
|---|---|---|---|---|---|---|---|
| | Dual LED | (18a) | | | Light String 2 (18b) | | |
| | Bulb | | WW | Color | | WW | Color |
| | diode 1 (22a)/ | Lighting | diode 1 | diode | Lighting | diode | diode 2 |
| Function/Mode | diode 2 (22b) | effect | (22a) | 2 (22b) | effect | 1 (22a) | (22b) |
| Mode 1 | WW + WW | Steady | ON | OFF | Steady | ON | OFF |
| Mode 2 | WW + WW | Flashing | ON | OFF | Flashing | ON | OFF |
| Mode 3 | WW + WW | Fading | ON | OFF | Fading | ON | OFF |
| Mode 4 | WW + WW | Slow Glow | ON | OFF | Slow | ON | OFF |
| | | | | | Glow | | |
| Mode 5 | WW + WW | Steady | ON | OFF | Twinkle | ON | OFF |
| Mode 6 | WW + WW | Steady | ON | OFF | Flashing | ON | OFF |
| Mode 7 | WW + WW | Steady | ON | OFF | Fading | ON | OFF |
| Mode 8 | WW + WW | Steady | ON | OFF | Slow | ON | OFF |
| | | | | | Glow | | |
| Mode 9 | Multi + Multi | Steady | OFF | ON | Steady | OFF | ON |
| Mode 10 | Multi + Multi | Flashing | OFF | ON | Flashing | OFF | ON |
| Mode 11 | Multi + Multi | Fading | OFF | ON | Fading | OFF | ON |
| Mode 12 | Multi + Multi | Slow Glow | OFF | ON | Slow | OFF | ON |
| | | | | | Glow | | |
| Mode 13 | Multi + Multi | Steady | OFF | ON | Twinkle | OFF | ON |
| Mode 14 | Multi + Multi | Steady | OFF | ON | Flashing | OFF | ON |
| Mode 15 | Multi + Multi | Steady | OFF | ON | Fading | OFF | ON |
| Mode 16 | Multi + Multi | Steady | OFF | ON | Slow | OFF | ON |
| | | | | | Glow | | |
| Mode 17 | Multi + WW | Steady | OFF | ON | Steady | ON | OFF |
| Mode 18 | Multi + WW | Steady | OFF | ON | Twinkle | ON | OFF |
| Mode 19 | Multi + WW | Steady | OFF | ON | Flashing | ON | OFF |
| Mode 20 | Multi + WW | Steady | OFF | ON | Fading | ON | OFF |
| Mode 21 | Multi + WW | Steady | OFF | ON | Slow | ON | OFF |
| | | | | | Glow | | |
| Mode 22 | Multi + WW | Flashing | OFF | ON | Twinkle | ON | OFF |
| Mode 23 | Multi + WW | Fading | OFF | ON | Twinkle | ON | OFF |
| Mode 24 | Multi + WW | Slow Glow | OFF | ON | Twinkle | ON | OFF |
| Mode 25 | WW + Multi | Steady | ON | OFF | Steady | OFF | ON |
| Mode 26 | WW + Multi | Steady | ON | OFF | Twinkle | OFF | ON |
| Mode 27 | WW + Multi | Steady | ON | OFF | Flashing | OFF | ON |
| Mode 28 | WW + Multi | Steady | ON | OFF | Fading | OFF | ON |
| Mode 29 | WW + Multi | Steady | ON | OFF | Slow | OFF | ON |
| | | | | | Glow | | |
| Mode 30 | WW + Multi | Flashing | ON | OFF | Twinkle | OFF | ON |
| Mode 31 | WW + Multi | Fading | ON | OFF | Twinkle | OFF | ON |
| Mode 32 | WW + Multi | Slow Glow | ON | OFF | Twinkle | OFF | ON |

In Table 1, above, WW represents a white or warm white illumination and Multi represents a color illumination other than white. In Table 1, for example, in lighting mode 1, the white diodes 22a in the bulbs 20 in light string 1 18a are illuminated and are a steady illumination, and the white diodes 22a in the bulbs 20 in light string 2 18b are illuminated white and are a steady illumination, so the effect is that the entirety of the LED lighting system 10 is a steady on white illumination. It will be appreciated that the color diodes 22b in both light strings 18a, 18b are off in the scenario. In lighting mode 9, the color diodes 22b in the bulbs 20 in light string 1 18a are illuminated and are a steady illumination, and the color diodes 22b in the bulbs 20 in light string 2 18b are illuminated and are a steady illumination, so the effect is that the entirety of the LED lighting system 10 is a steady on color illumination. It will be appreciated that the white diodes 22a in both light strings 18a, 18b are off in the scenario.

As another example, in lighting mode 16, the color diodes 22b in the bulbs 20 in light string 1 18a are illuminated and are a steady illumination, and the color diodes 22b in the bulbs 20 in light string 2 18b are illuminated and are a slow glow illumination, so the effect is that a portion of the LED lighting system 10 is a steady on color illumination and another portion of the LED lighting system 10 is a slow glow color illumination. It will be appreciated that the white diodes 22a in both light strings 18a, 18b are off in the scenario.

And in lighting mode 24, the color diodes 22b in the bulbs 20 in light string 1 18a are illuminated and are a slow glow illumination, and the white diodes 22a in the bulbs 20 in light string 2 18b are illuminated and are a twinkle illumination, so the effect is that a portion of the LED lighting system 10 is a slow glow color illumination and another portion of the LED lighting system 10 is a white twinkle illumination. It will be appreciated that the white diodes 22a in light string 1 18a, and the color diodes 22b in light string 2 18b are off in the scenario.

Table 2 below illustrates another example in which the LED lighting system 10 has eighty (80) lighting scenarios or modes and a demonstration mode (not shown).

TABLE 2
Lighting Scenarios or Modes

| | Dual LED | Light String 1 (18a) | | | Light String 2 (18b) | | |
|---|---|---|---|---|---|---|---|
| | Bulb | | WW | Color | | WW | Color |
| Function/ | (diode 1 (22a)/ | Lighting | diode 1 | diode 2 | Lighting | diode 1 | diode 2 |
| Mode | diode 2 (22b)) | effect | (22a) | (22b) | effect | (22a) | (22b) |
| Mode 1 | WW + WW | Steady | ON | OFF | Steady | ON | OFF |
| Mode 2 | Multi + Multi | Steady | OFF | ON | Steady | OFF | ON |
| Mode 3 | WW + Multi | Steady | ON | OFF | Steady | OFF | ON |
| Mode 4 | Multi + WW | Steady | OFF | ON | Steady | ON | OFF |
| Mode 5 | WW + WW | Steady | ON | OFF | Twinkle | ON | OFF |
| Mode 6 | Multi + Multi | Steady | OFF | ON | Twinkle | OFF | ON |
| Mode 7 | WW + Multi | Steady | ON | OFF | Twinkle | OFF | ON |
| Mode 8 | Multi + WW | Steady | OFF | ON | Twinkle | ON | OFF |
| Mode 9 | WW + WW | Flashing | ON | OFF | Flashing | ON | OFF |
| Mode 10 | Multi + Multi | Flashing | OFF | ON | Flashing | OFF | ON |
| Mode 11 | WW + Multi | Flashing | ON | OFF | Flashing | OFF | ON |
| Mode 12 | Multi + WW | Flashing | OFF | ON | Flashing | ON | OFF |
| Mode 13 | WW + WW | Fading | ON | OFF | Fading | ON | OFF |
| Mode 14 | Multi + Multi | Fading | OFF | ON | Fading | OFF | ON |
| Mode 15 | WW + Multi | Fading | ON | OFF | Fading | OFF | ON |
| Mode 16 | Multi + WW | Fading | OFF | ON | Fading | ON | OFF |
| Mode 17 | WW + WW | Slow | ON | OFF | Slow | ON | OFF |
| | | Glow | | | Glow | | |
| Mode 18 | Multi + Multi | Slow | OFF | ON | Slow | OFF | ON |
| | | Glow | | | Glow | | |
| Mode 19 | WW + Multi | Slow | ON | OFF | Slow | OFF | ON |
| | | Glow | | | Glow | | |
| Mode 20 | Multi + WW | Slow | OFF | ON | Slow | ON | OFF |
| | | Glow | | | Glow | | |
| Mode 21 | WW + WW | Steady | ON | OFF | Flashing | ON | OFF |
| Mode 22 | Multi + Multi | Steady | OFF | ON | Flashing | OFF | ON |
| Mode 23 | WW + Multi | Steady | ON | OFF | Flashing | OFF | ON |
| Mode 24 | Multi + WW | Steady | OFF | ON | Flashing | ON | OFF |
| Mode 25 | WW + WW | Steady | ON | OFF | Fading | ON | OFF |
| Mode 26 | Multi + Multi | Steady | OFF | ON | Fading | OFF | ON |
| Mode 27 | WW + Multi | Steady | ON | OFF | Fading | OFF | ON |
| Mode 28 | Multi + WW | Steady | OFF | ON | Fading | ON | OFF |
| Mode 29 | WW + WW | Steady | ON | OFF | Slow | ON | OFF |
| | | | | | Glow | | |
| Mode 30 | Multi + Multi | Steady | OFF | ON | Slow | OFF | ON |
| | | | | | Glow | | |
| Mode 31 | WW + Multi | Steady | ON | OFF | Slow | OFF | ON |
| | | | | | Glow | | |
| Mode 32 | Multi + WW | Steady | OFF | ON | Slow | ON | OFF |
| | | | | | Glow | | |
| Mode 33 | WW + WW | Flashing | ON | OFF | Twinkle | ON | OFF |
| Mode 34 | Multi + Multi | Flashing | OFF | ON | Twinkle | OFF | ON |
| Mode 35 | WW + Multi | Flashing | ON | OFF | Twinkle | OFF | ON |
| Mode 36 | Multi + WW | Flashing | OFF | ON | Twinkle | ON | OFF |
| Mode 37 | WW + WW | Fading | ON | OFF | Twinkle | ON | OFF |
| Mode 38 | Multi + Multi | Fading | OFF | ON | Twinkle | OFF | ON |
| Mode 39 | WW + Multi | Fading | ON | OFF | Twinkle | OFF | ON |
| Mode 40 | Multi + WW | Fading | OFF | ON | Twinkle | ON | OFF |
| Mode 41 | WW + WW | Slow | ON | OFF | Twinkle | ON | OFF |
| | | Glow | | | | | |
| Mode 42 | Multi + Multi | Slow | OFF | ON | Twinkle | OFF | ON |
| | | Glow | | | | | |
| Mode 43 | WW + Multi | Slow | ON | OFF | Twinkle | OFF | ON |
| | | Glow | | | | | |
| Mode 44 | Multi + WW | Slow | OFF | ON | Twinkle | ON | OFF |
| | | Glow | | | | | |
| Mode 45 | WW + WW | Flashing | ON | OFF | Steady | ON | OFF |
| Mode 46 | Multi + Multi | Flashing | OFF | ON | Steady | OFF | ON |
| Mode 47 | WW + Multi | Flashing | ON | OFF | Steady | OFF | ON |
| Mode 48 | Multi + WW | Flashing | OFF | ON | Steady | ON | OFF |
| Mode 49 | WW + WW | Flashing | ON | OFF | Fading | ON | OFF |
| Mode 50 | Multi + Multi | Flashing | OFF | ON | Fading | OFF | ON |
| Mode 51 | WW + Multi | Flashing | ON | OFF | Fading | OFF | ON |
| Mode 52 | Multi + WW | Flashing | OFF | ON | Fading | ON | OFF |
| Mode 53 | WW + WW | Flashing | ON | OFF | Slow | ON | OFF |
| | | | | | Glow | | |
| Mode 54 | Multi + Multi | Flashing | OFF | ON | Slow | OFF | ON |
| | | | | | Glow | | |
| Mode 55 | WW + Multi | Flashing | ON | OFF | Slow | OFF | ON |
| | | | | | Glow | | |
| Mode 56 | Multi + WW | Flashing | OFF | ON | Slow | ON | OFF |
| | | | | | Glow | | |
| Mode 57 | WW + WW | Fading | ON | OFF | Steady | ON | OFF |
| Mode 58 | Multi + Multi | Fading | OFF | ON | Steady | OFF | ON |
| Mode 58 | WW + Multi | Fading | ON | OFF | Steady | OFF | ON |
| Mode 60 | Multi + WW | Fading | OFF | ON | Steady | ON | OFF |
| Mode 61 | WW + WW | Fading | ON | OFF | Flashing | ON | OFF |
| Mode 62 | Multi + Multi | Fading | OFF | ON | Flashing | OFF | ON |
| Mode 63 | WW + Multi | Fading | ON | OFF | Flashing | OFF | ON |
| Mode 64 | Multi + WW | Fading | OFF | ON | Flashing | ON | OFF |
| Mode 65 | WW + WW | Fading | ON | OFF | Slow | ON | OFF |
| | | | | | Glow | | |
| Mode 66 | Multi + Multi | Fading | OFF | ON | Slow | OFF | ON |
| | | | | | Glow | | |
| Mode 67 | WW + Multi | Fading | ON | OFF | Slow | OFF | ON |
| | | | | | Glow | | |
| Mode 68 | Multi + WW | Fading | OFF | ON | Slow | ON | OFF |
| | | | | | Glow | | |
| Mode 69 | WW + WW | Slow | ON | OFF | Steady | ON | OFF |
| | | Glow | | | | | |
| Mode 70 | Multi + Multi | Slow | OFF | ON | Steady | OFF | ON |
| | | Glow | | | | | |
| Mode 71 | WW + Multi | Slow | ON | OFF | Steady | OFF | ON |
| | | Glow | | | | | |
| Mode 72 | Multi + WW | Slow | OFF | ON | Steady | ON | OFF |
| | | Glow | | | | | |
| Mode 73 | WW + WW | Slow | ON | OFF | Flashing | ON | OFF |
| | | Glow | | | | | |
| Mode 74 | Multi + Multi | Slow | OFF | ON | Flashing | OFF | ON |
| | | Glow | | | | | |
| Mode 75 | WW + Multi | Slow | ON | OFF | Flashing | OFF | ON |
| | | Glow | | | | | |
| Mode 76 | Multi + WW | Slow | OFF | ON | Flashing | ON | OFF |
| | | Glow | | | | | |
| Mode 77 | WW + WW | Slow | ON | OFF | Fading | ON | OFF |
| | | Glow | | | | | |
| Mode 78 | Multi + Multi | Slow | OFF | ON | Fading | OFF | ON |
| | | Glow | | | | | |
| Mode 79 | WW + Multi | Slow | ON | OFF | Fading | OFF | ON |
| | | Glow | | | | | |
| Mode 80 | Multi + WW | Slow | OFF | ON | Fading | ON | OFF |
| | | Glow | | | | | |

Similar to the examples presented above with respect to Table 1, in Table 2, WW represents a white or warm white illumination and Multi represents a color illumination other than white. In Table 2, for example, in lighting mode 1, the white diodes 22a in the bulbs 20 in light string 1 18a are illuminated and are a steady illumination, and the white diodes 22a in the bulbs 20 in light string 2 18b are illuminated white and are a steady illumination (the color diodes 22b in both strings 18a, 18b are off), so the effect is that the entirety of the LED lighting system 10 is a steady on white illumination. In lighting mode 9, the white diodes 22a in the bulbs 20 in light string 1 18a are illuminated and are a flashing illumination, and the white diodes 22b in the bulbs 20 in light string 2 18b are illuminated and are a flashing illumination (the color diodes 22b are off), so the effect is that the entirety of the LED lighting system 10 is a flashing on white illumination.

In lighting mode 20, the color diodes 22b in the bulbs 20 in light string 1 18a are illuminated and are a slow glow illumination, and the white diodes 22a in the bulbs 20 in light string 2 18b are illuminated and are a slow glow illumination, so the effect is that a portion of the LED lighting system 10 is a slow glow color illumination and a portion of the LED lighting system 10 is a slow glow white illumination. It will be appreciated that in this scenario the white diodes 22a in light string 1 18a are off and the color diodes 22b in light string 2 18b are off.

The multi-function, multi-string LED lighting system 10 can include multiple sets of light strings 18a,b. For example, the system 10 illustrated in FIG. 1 can include includes four wire sets 16 (a), 16 (b), 16 (c), 16 (d), in which each wire set 16 (a), 16 (b), 16 (c), 16 (d), includes first and second light strings 18a,b (see also FIG. 6), and in which each light string 18a,b is controlled from a single controller 14. It will be appreciated that the system 10 can include a single set of first and second light strings 18a,b or many sets of first and second light strings 18a.b.

In a current embodiment, each first set of light strings 18a functions in a coordinated manner (are illuminable in a coordination) with each other first set of light strings 18a (having the same effect, e.g., steady, flashing, fading, slow glow, or twinkle illumination as each other first or second light strings). That is, each of the first light strings 18a has the same effect as each other first light string 18a and each of the second light strings 18b has the same effect as each other second light string 18b. It is, however, contemplated that each first light string 18a need not function in the same manner as each other first light string 18a, and each second light string 18b need not function in the same manner as each other second light string 18b.

The placement of the bulbs 20 along each light string 18a,b can also be varied. That is, each bulb 20 on the first light string 18a can be placed at a same or at a different location from each bulb 20 on the second light string 18b. The light strings 18a,b can also have different numbers of bulbs on each string. That is string 18a can have, for example seventy percent (70%) of the total number of bulbs 20 in the system 10, and light string 18b can have thirty percent (30%) of the total number of bulbs 20 in the system 10. In such an embodiment, the light string 18a with the greater number of bulbs 20 can be referred to as a primary light string and the light string 18b with the lesser number of bulbs 20 can be referred to as a secondary light string. Such an arrangement is illustrated in FIG. 7 in which light string 18a has twice as many bulbs 20a as the bulbs 20b in light string 18b. The percentage of bulbs in any given string can, of course very from the 70/30 percent arrangement to any number, and the light strings 18a, 18b can have the same number of bulbs.

It will be appreciated that there are different “types” of LEDs that can be used. Some of the LEDs are single color LEDs, such as white LEDs, red LEDs, green LEDs, and blue LEDs. Some are multi color LEDs that have multiple diodes within the LED. These can be red/green/blue LEDs referred to as RGB LEDs, or can be red/green/blue/white LEDs, referred to RGBW LEDs. Any of these can be used in the present system and as described herein, with the present controllers. It will be appreciated that white LEDs refers to any color temperature white, such as warm white, bright white, etc.

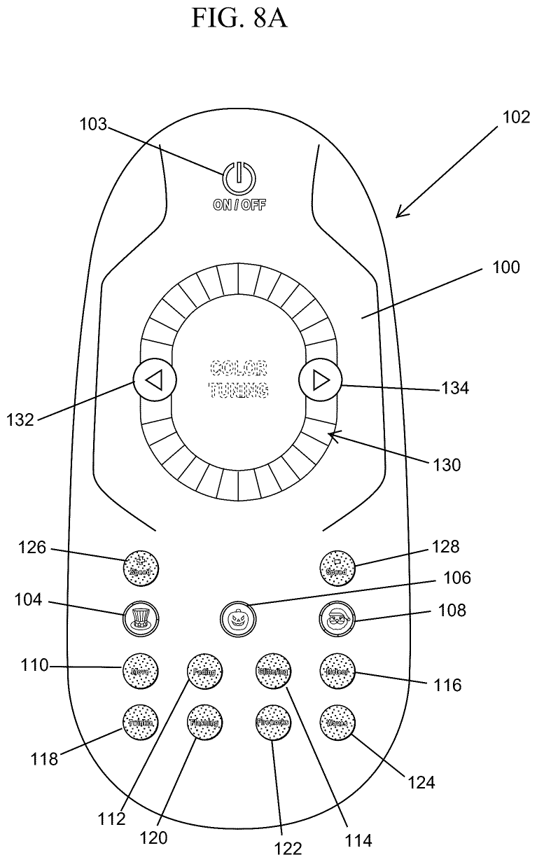

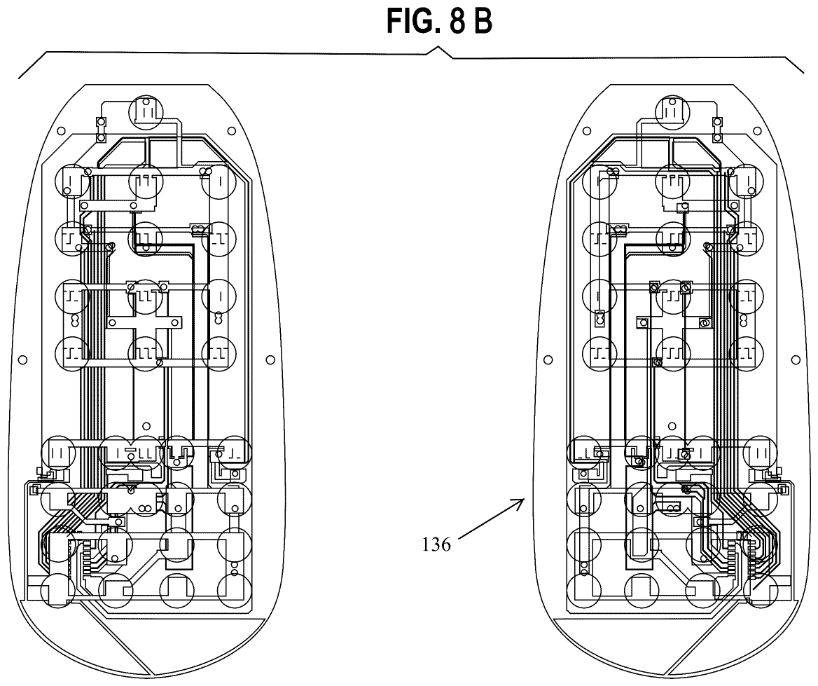

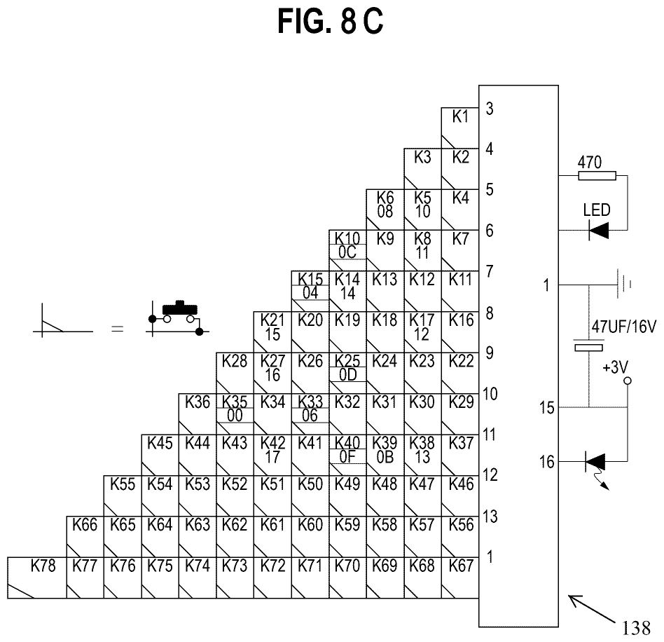

FIG. 8A illustrates one example of a face panel 100 for a controller 102 for the multi-function, multi-string light system 10. The controller 102 includes a power button 103 three preset holiday buttons: Independence Day 104 (for example, red, white, and blue), Halloween 106 (for example, purple, green, and orange), and Christmas 108 (for example, red, green, and white). Depressing any of these buttons 104, 106, 108 will illuminate the bulbs 20 in the appropriate holiday colors without having to scan through a host of colors and designs to illuminate the appropriate holiday colors.

In addition, the controller 102 has function buttons that can be used to change the illuminating function (for example, blinking illumination, steady illumination, etc.). In an embodiment, the controller 102 can include function buttons such as move 110, fading 112, glittering 114, meteor 116, twinkle 118, flashing 120, fireworks 122 and waves 124. The controller 102 can also include buttons 126, 128 to increase and decrease the speed of the selected function. In an embodiment of a lighting system 10 that includes the preset holiday colors, it is anticipated that the bulbs will include RGB LEDs and white LEDs, or RGBW LEDs and white LEDs, or RGBWW LEDs and white LEDs, although separate, individual color LEDs (i.e., separate red, green, blue, white) can be used.

The controller 102 can also include a color tuning ring 130 that includes the spectrum of colors. Using the color tuning ring, the colors of the LEDs can be changed/adjusted to other than the preset holiday colors. This provides illumination in essentially the full spectrum of colors (red, orange, yellow, green, blue, indigo, and violet) which are on the ring 130 (but not shown) and can, in combination with the white LED or the white of the RGBW LED provide various hues (lightness/darkness) of any of these colors. One embodiment of a tuning ring 130 includes buttons 132, 134 on the ring 130 about opposite one another to change the colors of the LEDs.

FIGS. 8B and 8C illustrate a printed circuit board layout 136 (FIG. 8B) and a schematic diagram 138 (FIG. 8C) for the controller 102.

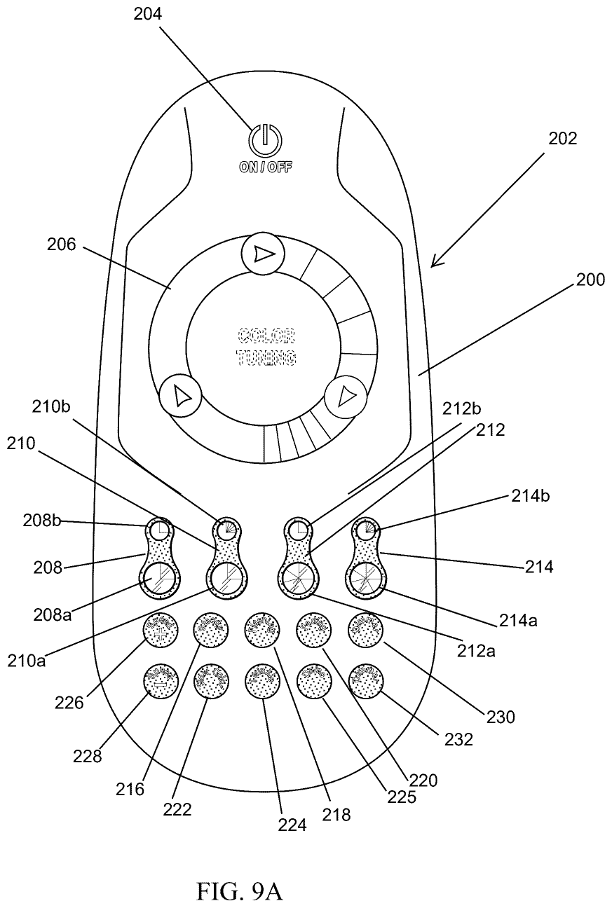

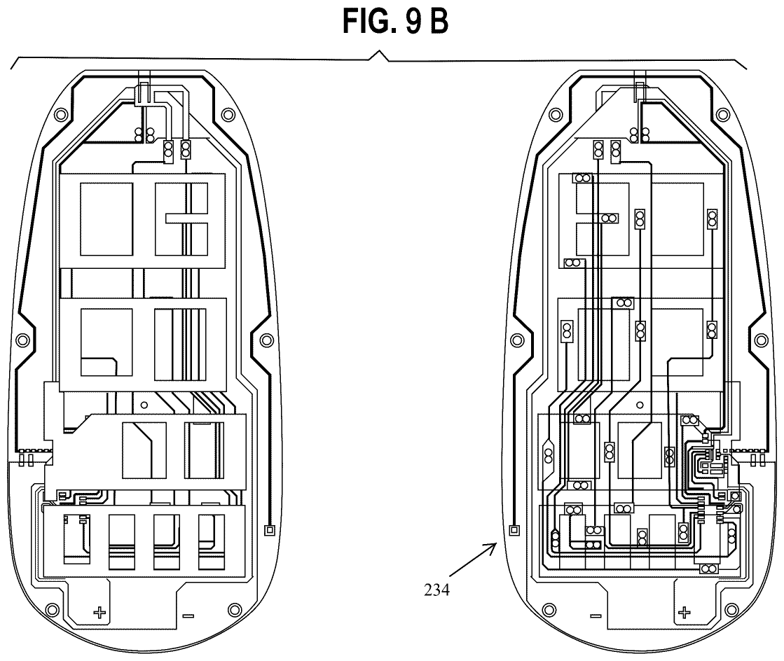

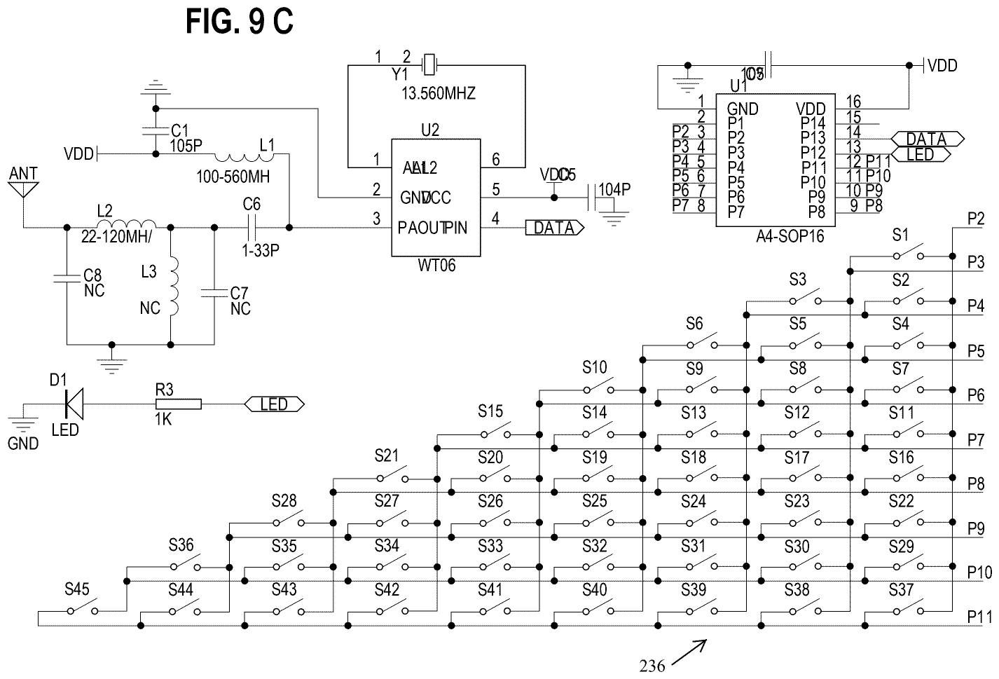

FIG. 9A illustrates another example of a face panel 200 for a controller 202 for the multi-function, multi-string LED lighting system 10. The face 200 panel includes a power switch 204, a color tuning ring 206, four pre-programmed color buttons sets 208, 210, 212, 214, each including a primary light string button 208a, 210a, 212a, 214a, and a secondary light string button 208b, 210b, 212b, 214b, and a plurality of function buttons. In a present embodiment, the function buttons include a steady illumination button 216, a flashing illumination button 218, a fading illumination button 220, a slow glow illumination button 222, and a twinkle illumination button 224. The controller also includes a speed increase button 226 and a speed decease button 228, and a dimmer increase button 230 and a dimmer decrease button 232.

As noted above, one of the light strings 18a can be a primary light string and can be represented by a larger icon in the pre-programmed color button sets 208a, 210a, 212a, 214a and the secondary light string can be represented by a smaller icon in the pre-programmed button sets 208b, 210b, 212b, 214b. Referring to the pre-programmed button 208 the primary light string button 208a (which shows about seventy five percent of the total number of lights), when depressed, illuminates the primary light string 18a in a white color. Likewise, when secondary light string button 208b (which shows about twenty five percent of the total number of lights), when depressed, illuminates the secondary light string 18b in a white color.

As described above, light strings 18a,b function independently of one another. As such, with primary light string 18a illuminated in a white color, pre-programmed button set secondary light string button 208b can be depressed and the secondary light string 18b illuminates in colors. It will be appreciated that: pre-programmed button set 208 primary light string button 208a illuminates the primary light string 18a in white and pre-programmed button set 208 secondary light string button 208b illuminates the secondary light string 18b in white; pre-programmed button set 210 primary light string button 210a illuminates the primary light string 18a in white and pre-programmed button set 210 secondary light string button 210b illuminates the secondary light string 18b in colors; pre-programmed button set 212 primary light string button 212a illuminates the primary light string 18a in colors and pre-programmed button set 212 secondary light string button 212b illuminates the secondary light 18b string in white; and pre-programmed button set 214 primary light string 214a button illuminates the primary light string 18a in colors and pre-programmed button set 214 secondary light string button 214b illuminates the secondary light string 18b in colors.

In addition, the controller 202 has function buttons that can be used to change the illuminating function (for example, blinking illumination, steady illumination, etc.). In an embodiment, the controller 202 can include function buttons such as steady 216, flashing 218, fading 220, slow glow 222, twinkle 224, and demo 225. The controller can also include buttons to increase 226 and decrease 228 the speed of the selected function and to dim 230 and brighten 232 the LEDs. In an embodiment, that the LEDs can be separate, individual color LEDs (i.e., separate red, green, blue, white), although RGB and white LEDs or RGBW LEDs can be used.

FIGS. 9B and 9C illustrate the printed circuit board layout 234 (FIG. 9B) and schematic diagram 236 (FIG. 9C) for the controller 202.

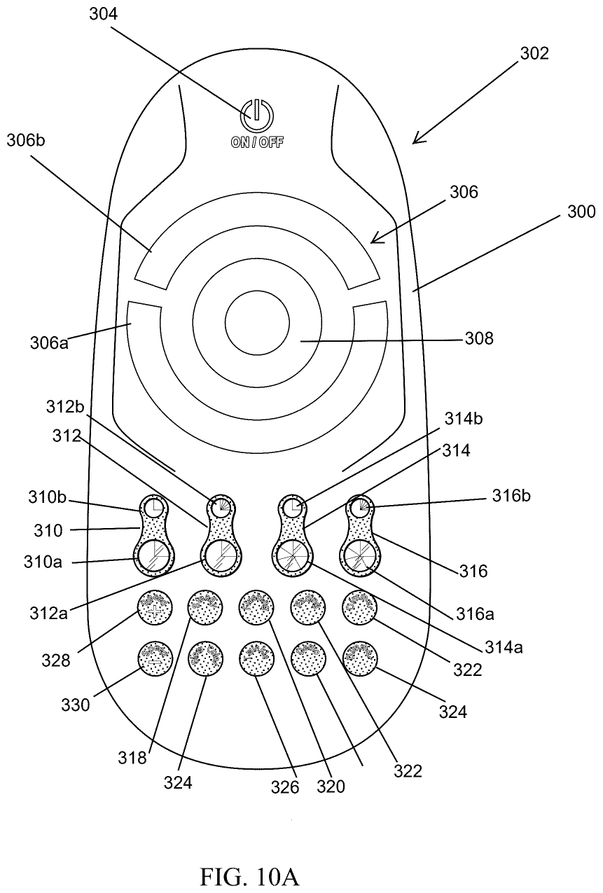

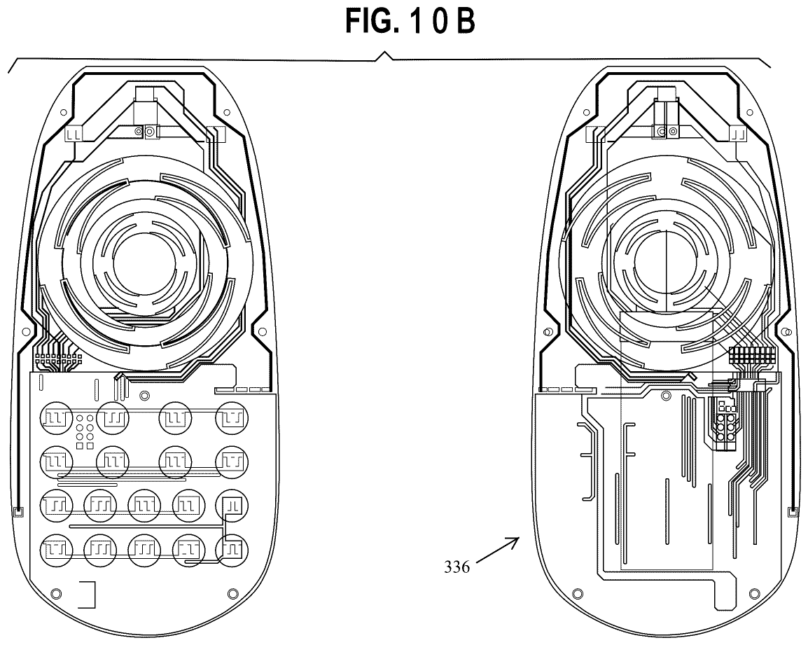

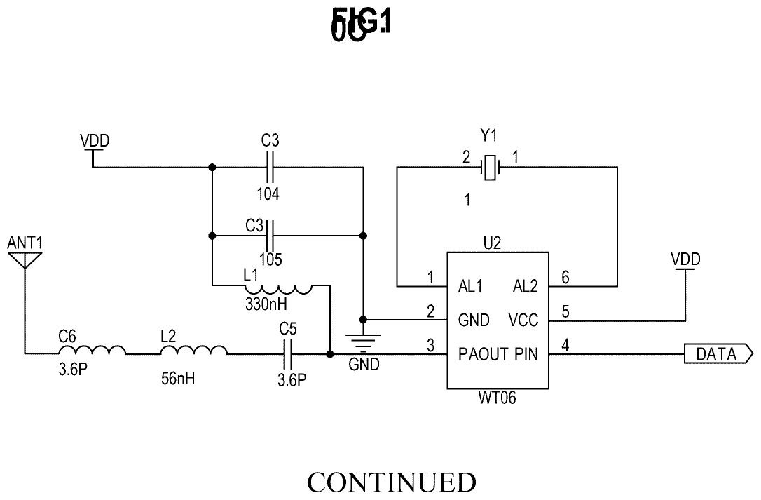

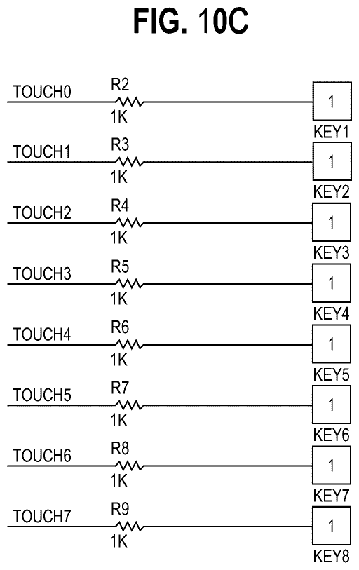

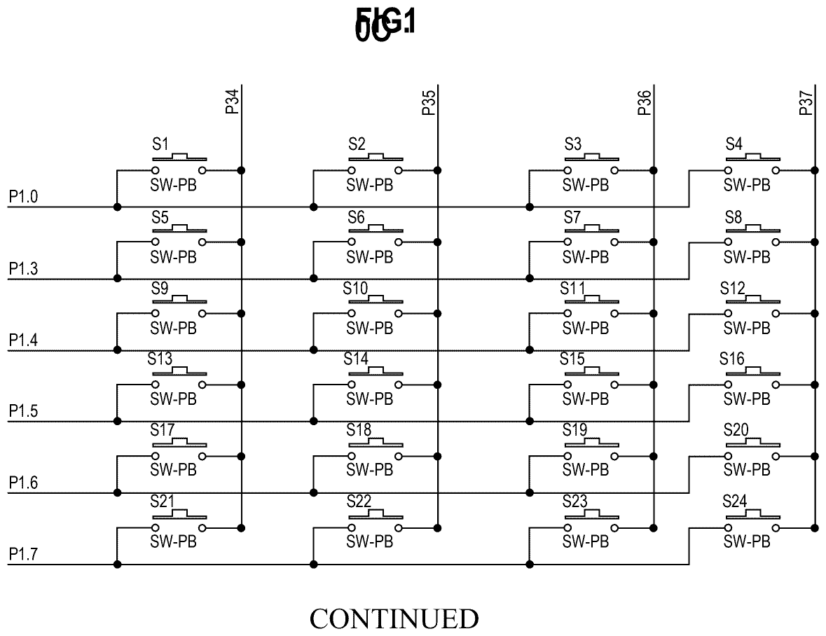

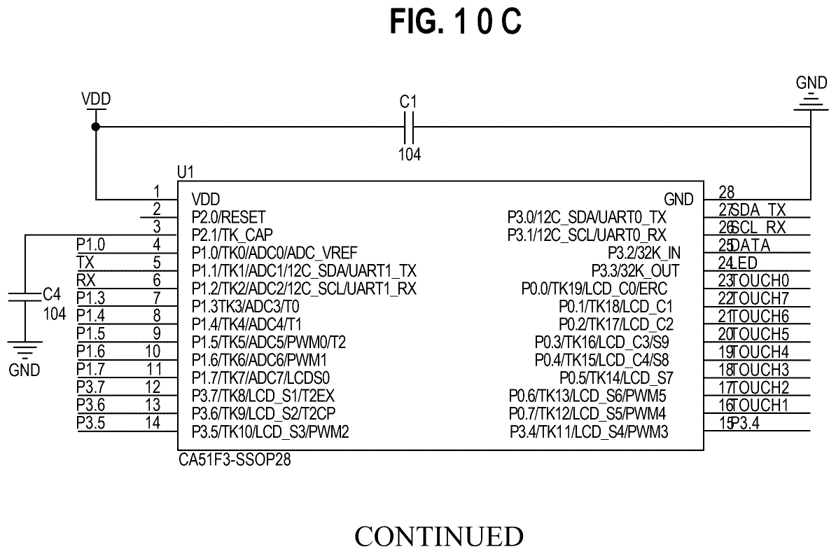

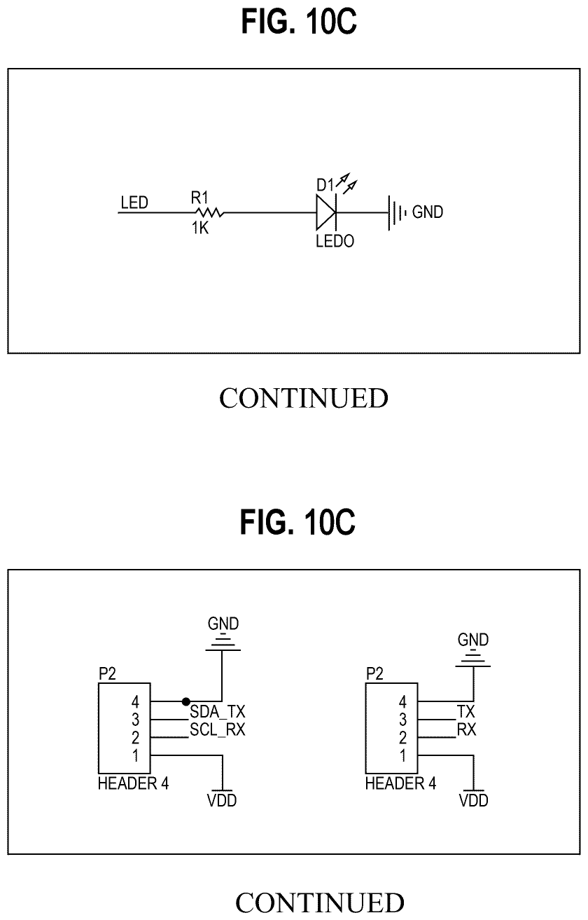

FIG. 10A illustrates still another embodiment of a face panel 300 for a controller 302 for the multi-function, multi-string LED lighting system 10. The face panel 300 includes a power switch 304, two color tuning rings 306, 308, four pre-programmed color buttons sets 310, 312, 314, 316, each including a primary light string button 310a, 312a, 314a, 316a and a secondary light string button 310b, 312b, 314,b, 316b, and a plurality of function buttons. In a present embodiment, one of the color tuning rings 306 (the larger, outer ring) is divided into two partial rings, a larger portion 306a and a smaller portion 306b. The larger portion 306a of the outer ring 306 can be used to “tune” the color of primary light string 18a and the smaller portion 306b of the outer ring 306 can be used to “tune” the color of the secondary light string 18b. The smaller inner color tuning ring 308 can be used to “tune” both of the light strings 18a, 18b at the same time.

In a present embodiment, the function buttons include a steady illumination button 318, a flashing illumination button 320, a fading illumination button 322, a slow glow illumination button 324, and a twinkle illumination button 326. The controller 302 also includes a speed increase button 328 and a speed decease button 330, and a dimmer increase button 332 and a dimmer decrease button 334.

As noted above, one of the light strings can be a primary light string 18a and can be represented by the larger icons 310a, 312a, 314a, 316a, in the pre-programmed color button sets 310, 312, 314, 316, and the secondary light string 18b can be represented by the smaller icons 310b, 312b, 314b, 316b, in the pre-programmed button sets 31, 312, 314, 316.

Referring to pre-programmed button 310, the primary light string button 310a (which shows about seventy five percent of the total number of lights), when depressed, illuminates the primary light string 18a in a white color. Likewise, when secondary light string button 310b (which shows about twenty five percent of the total number of lights), when depressed, illuminates the secondary light string 18b in a white color. As noted above, light strings 18a,b can function independently of one another.

As such, with primary light string 18a illuminated in a white color, pre-programmed button set 312 secondary light string button 312b can be depressed and the secondary light string 18b illuminates in colors. It will be appreciated that: pre-programmed button set 314 primary light string button 314a illuminates the primary light string 18a in colors and pre-programmed button set 314 secondary light string button 314b illuminates the secondary light string 18b in white; and pre-programmed button set 316 primary light string button 316a illuminates the primary light string 18a in colors and pre-programmed button set 316 secondary light string button 316b illuminates the secondary light string 18b in colors.

It is anticipated that in order to obtain a full spectrum of colors (red, orange, yellow, green, blue, indigo, and violet) in combination with a white illumination, RGB or RGBW LEDs will be used to provide the various colors and hues (lightness/darkness) of any of these colors.

In addition, the controller has function buttons that can be used to change the illuminating function (for example, blinking illumination, steady illumination, etc.). In an embodiment, the controller can include function buttons such as steady, flashing, fading, slow glow, twinkle, and demo. The controller can also include buttons to increase and decrease the speed of the selected function and to dim and brighten the LEDs.

FIGS. 10B and 10C illustrate the printed circuit board layout 336 (FIG. 10B) and schematic diagram 338 (FIG. 10C) for the controller 302.

In order to create a pleasing visual effect with white and multiple colors illuminated in the same or different modes, the first and second light strings 18a,b can be physically intertwined or joined to one another. Such an effect facilitates creating even more pleasing visual effects of the multi-function, multi-string LED lighting system 10.

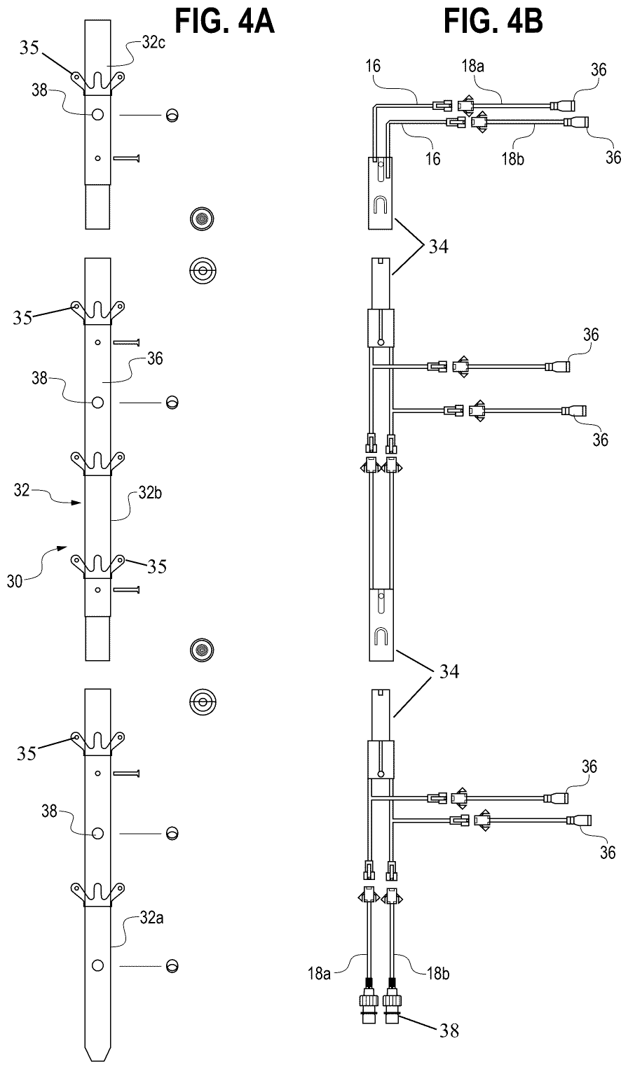

FIG. 4 illustrates one contemplated use of the LED lighting system 10. In the illustrated use, the LED lighting system 10 is part of an upstanding structure 30 that can be self-supporting, such as a holiday tree, such as an artificial Christmas tree. The tree 30 includes a hollow central post 32, which post 32 can be provided in sections 32a-c that are joined to one another. The central post 32 is hollow.

Wire sets 16 include electro-mechanical trunk connectors 34 can be positioned in the hollow central post 32 and portions of the wire sets 16 can be pulled through openings 38 in the post 32 to run the light strings 18a,b out along branches (not shown) of the tree 30. The branches can be joined to the post 32, e.g., trunk sections, at branch connectors 35. The trunk connectors 34 can be “hidden” within the posts 32 to further the aesthetics of the tree 30. The light strings 18a, 18b can be connected to the controller 14 by connectors 38, and extensions of light sets 18a, 18b can be joined to additional light sets 18a, 18b at connectors 36. As noted above, the first and second light strings 18a,b can be physically intertwined or joined to one another to create an even more pleasing visual effect of the multi-function, multi-string LED lighting system 10.

The words “a” or “an” are to be taken to include both the singular and the plural. Conversely, any reference to plural items shall, where appropriate, include the singular. The words “first,” “second,” “third,” and the like may be used in the present disclosure to describe various information, such information should not be limited to these words. These words are only used to distinguish one category of information from another. The directional words “top,” “bottom,” “up,” “down,” front,” “back,” and the like are used for purposes of illustration and as such, are not limiting. Depending on the context, the word “if” as used herein may be interpreted as “when” or “upon” or “in response to determining.”

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. An LED lighting system, comprising:
an AC/DC and/or DC/DC power converter;
a controller;
a first light set comprising a first light string and a second light string, each the first light string and the second light string having a plurality of bulbs, each bulb having a first diode and a second diode, the first diode and the second diode emitting light of a different color from each other, the first light string and the second light string electrically connected to the controller and illuminable independently of one another.

2. The LED lighting system of claim 1, wherein the first diodes of the first light string emit a white light and wherein the second diodes of the first light string emit a light of a color other than white.

3. The LED lighting system of claim 1, wherein the first diodes of the second light string emit a white light and wherein the second diodes of the second light string emit a light of a color other than white.

4. The LED lighting system of claim 2, wherein the color other than white is one or more of red, green, blue, purple, and orange.

5. The LED lighting system of claim 3, wherein the color other than white is one or more of red, green, blue, purple, and orange.

6. The LED lighting system of claim 1, wherein the LEDs are RGB LEDs.

7. The LED lighting system of claim 1, wherein the LEDs are RGBW LEDs.

8. The LED lighting system of claim 1, wherein each first diode and each second diode is illuminable in one or more of a steady illumination, a flashing illumination, a fading illumination, a slow glow illumination, and a twinkle illumination

9. The LED lighting system of claim 1, further including a second light set, wherein the second light set includes a second light set first light string and a second light set second light string, each the second light set first light string and the second light set second light string having a plurality of bulbs, each bulb having a first diode and a second diode, the first and second diodes emitting light of a different color from each other, the second light set first and second light strings electrically connected to the controller and illuminable independently of one another.

10. The LED lighting system of claim 9, wherein the first light set and the second light set are illuminable in coordination with one another.

11. The LED lighting system of claim 9 further including a third light set.

12. The LED lighting system of claim 11, wherein the first light set, the second light set, and the third light set are illuminable in coordination with one another.

13. The LED lighting system of claim 11 further including a fourth light set.

14. The LED lighting system of claim 13, wherein the first light set, the second light set, the third light set, and the fourth light set are illuminable in coordination with one another.

15. The LED lighting system of claim 1, wherein the LED light set is illuminable in at least eight lighting scenarios.

16. The LED lighting system of claim 15, wherein the LED light set is illuminable in at least thirty-two lighting scenarios.

17. The LED lighting system of claim 16, wherein the LED light set is illuminable in at least eighty lighting scenarios.

18. An upstanding structure having an LED lighting system, comprising:
a self-supporting structure;
an AC/DC and/or DC/DC power converter;
a controller;
a first light set comprising a first light string and a second light string, each the first light string and the second light string having a plurality of bulbs, each bulb having a first diode and a second diode, the first diode and the second diode emitting light of a different color from each other, the first light string and the second light string electrically connected to the controller and illuminable independently of one another.

19. The upstanding structure of claim 18, wherein the upstanding structure is a post of an artificial tree.

20. A controller for use with an LED lighting system having an AC/DC and/or DC/DC power converter and a first light set comprising a first light string and a second light string, each the first light string and the second light string having a plurality of bulbs, each bulb having a first diode and a second diode, the first diode and the second diode emitting light of a different color from each other, the first light string and the second light string electrically connected to the controller and illuminable independently of one another, the controller comprising:
a face plate having a plurality of switches, the switches including at least three preset switches, each preset switch illuminating the first light string illuminated in a first color and the second light string illuminated in a second color, the controller configured to illuminate the first and second light strings independent of each other.

21. The controller of claim 20, wherein the first color is different from the second color.

22. The controller of claim 20, wherein the first color is the same as the second color.

23. The controller of claim 20, wherein the at least three preset switches illuminate the first and second light strings in holiday themed colors.

24. The controller of claim 23, wherein the holiday themed colors include red, white, and blue for United States Independence Day, purple, green, and orange for Halloween, and red, green, and white for Christmas.
